(19) United States
(12) Patent Application Publication
(10) Pub. No.: US 2005/0251302 A1
(43) Pub. Date: Nov. 10, 2005

(54) System and method for managing vehicle inspections

(75) Inventor: Tomohiro Tsubota, Nagoya-shi (JP)

Correspondence Address: BIRCH STEWART KOLASCH & BIRCH, PO BOX 747, FALLS CHURCH, VA, 22040-0747, US

(73) Assignee: Mitsubishi Jidosha Kogyo Kabushiki Kaisha, Tokyo (JP)

(21) Appl. No.: 11/104,569

(22) Filed: Apr. 13, 2005

(30) Foreign Application Priority Data
Apr. 15, 2004 (JP) 2004-120106

(51) Int. Cl. G06F 7/00

(52) U.S. Cl. 701/29; 701/35

(57) ABSTRACT

The present invention provides a system for managing vehicle inspections, the system including a server used on a vehicle production line and having an inspection master database which stores inspection items for parts to be repaired, and a repair terminal and a repair checking terminal which communicate with the server via a LAN and which are used in a plurality of inspection stages. The server includes a transmitting section which extracts, on the basis of repair information on a part to be repaired which is transmitted by the repair terminal, inspection items related to this part to be repaired, from the inspection master data, and which transmits the inspection items to the repair checking terminal as re-inspection items. The repair checking terminal includes a display, and a display section which displays, on the display, the re-inspection items for the part to be repaired which have been transmitted by the server.

### CROSS-REFERENCE TO RELATED APPLICATIONS

This application is based upon and claims the benefit of priority from prior Japanese Patent Application No. 2004-120106, filed Apr. 15, 2004, the entire contents of which are incorporated herein by reference.

### BACKGROUND OF THE INVENTION

1. Field of the Invention

The present invention relates to a system and method for managing vehicle inspections on a vehicle production line.

2. Description of the Related Art

Conventional automobile production lines are classified into the following two types. In a first type, a plurality of inspecting stages are set for a vehicle. In each inspecting stage, inspection data is downloaded from a host computer into a personal computer. An inspector carries out inspections on the basis of the inspection data. The inspector then inputs the results of the inspections to the personal computer to transmit them to the host computer. In a second type, at the beginning of the inspections, an inspection instruction sheet is created by printing reference data required for inspections in the respective stages, on a sheet in a bar code form. The inspection instruction sheets are then attached to the vehicle. In the first stage, the bar code is read to obtain the reference data. Inspections are then carried out on the basis of the reference data. A bar code label indicating the results is then created and applied to the inspection instruction sheet. Thus, together with the vehicle, the inspection instruction sheet is transferred to the next stage (see, for example, Jpn. Pat. Appln. KOKAI Publication No. 2002-12177).

If any defect is found as a result of the inspections based on the inspection instruction sheet, it must be repaired in the subsequent stage (that is, a repair stage).

Further, during the stage of repairing the defect, a new defect may occur.

### BRIEF SUMMARY OF THE INVENTION

It is an object of the present invention to provide a system and method for managing vehicle inspections in which repair information obtained during a repair stage of repairing a defect found in an inspection stage is collected so that the repaired part can be reliably re-inspected.

According to one aspect of the invention, there is provided a system for managing vehicle inspections, the system comprising a server used on a vehicle production line and including an inspection master database which stores inspection items for parts to be repaired; and a repair terminal and a repair checking terminal which communicate with the server via a LAN and which are used in a plurality of inspection stages,
wherein the server comprises:
a transmitting section configured to extract, on the basis of repair information on a part to be repaired which is transmitted by the repair terminal, inspection items related to this part to be repaired, from the inspection master data, and to transmit the inspection items to the repair checking terminal as re-inspection items, and
the repair checking terminal comprises:
a display; and
a display section configured to display, on the display, the re-inspection items for the part to be repaired which have been transmitted by the server.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the configuration of an inspection managing system according to an embodiment of the present invention;

FIG. 2 is a block diagram showing the hardware configuration of a server according to the embodiment;

FIG. 3 is a block diagram showing the hardware configuration of a master managing terminal according to the embodiment;

FIG. 4 is a diagram showing the hardware configuration of an portable inspection terminal, a portable repair terminal, and a repair checking portable terminal;

FIG. 5 is a flowchart illustrating a process executed by the master managing terminal according to the embodiment;

FIG. 6 is a flowchart illustrating a process executed by the server according to the embodiment; and

FIG. 7 is a flowchart illustrating a process executed by the portable repair checking terminal according to the embodiment.

### DETAILED DESCRIPTION OF THE INVENTION

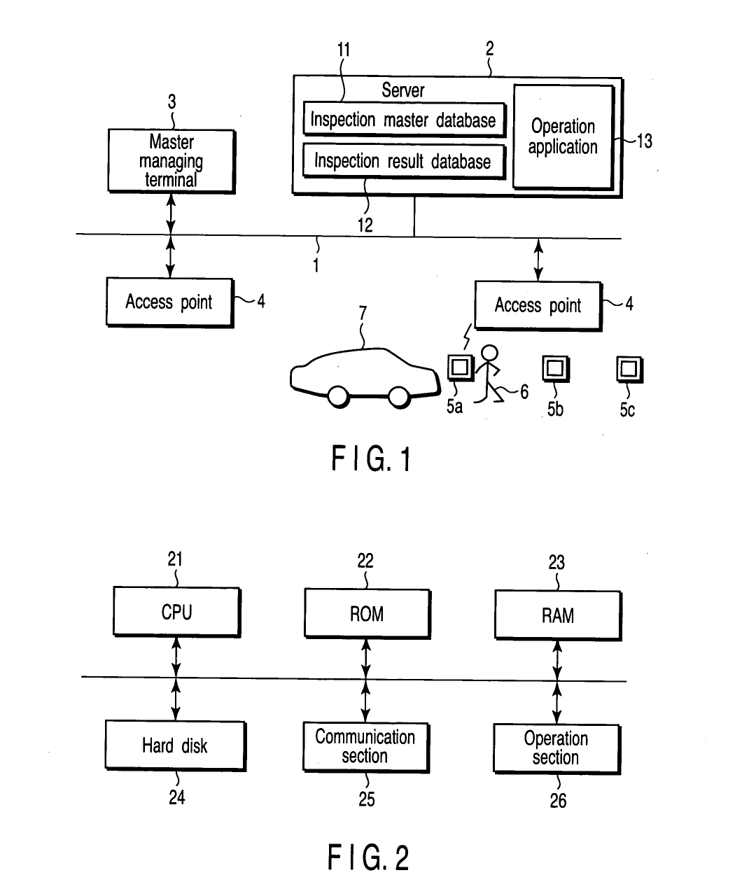

With reference to the drawings, description will be given of operations of an embodiment of the present invention. FIG. 1 is a diagram showing the configuration of a system for managing vehicle inspections. In the figure, reference numeral 1 denotes a LAN placed in a vehicle manufacturing plant. The LAN 1 connects to a server 2, a master managing terminal 3, and a plurality of access points 4. Each of the access points 4 communicates wirelessly with a portable inspection terminal 5a serving as an terminal inspection, a portable repair terminal 5b serving as a repair terminal, and a portable repair checking terminal 5c serving as a repair checking terminal; these portable terminals are mobile terminals located close to the access point 4.

The portable inspection terminal 5a is carried by an inspector 6. Every time a predetermined process on a production line is finished, the portable inspection terminal 5a is operated to inspect a plurality of sites or parts to be inspected which were integrated into an automobile 7 during the process.

The portable repair terminal 5b is carried by a repairer to repair a defect found during the inspection stage, in a subsequent repair checking stage, the inspection stage using the inspecting portable terminal 5a.

The portable repair checking terminal 5c is carried by a repair checker during a repair checking stage of checking whether or not the defect repaired during the repair stage has been appropriately executed.

The server 2 is provided with an inspection master database 11 and an inspection result database 12. The inspection master database 11 stores inspection item assignment information on parts to be repaired. The parts to be repaired mean parts in which defects found during the inspection stage have occurred. It is also necessary to inspect sites in which detects are likely to occur as a result of the repair of the parts in which the defects occurred. Such a site is called a site to be inspected. A set of a part to be repaired and a site to be inspected is called an inspection target item. The master managing terminal 3 sets inspection item assignment information for each part to be repaired. The server 2 also stores various operation applications 13.

The inspection result database 12 stores the results of actual inspections.

As shown in FIG. 2, the server 2 is provided with a central processing unit (CPU) 21 constituting a control section main body, a read-only memory (ROM) 22 that stores program data used by the CPU 21 to control each section, a random-access memory (RAM) 23 provided with a memory temporarily used by the CPU 21 to execute data transmission, reception, processing, or the like, a communication section 25 which transmits and receives data to and from the master managing terminal 3 via the LAN 1 and which transmits and receives data to and from the inspecting portable terminal 5 via the access point 4, and an operation section 26 used for key inputs, display of indicators, and the like. The components of the server 2 are electrically connected together by a bus line 27.

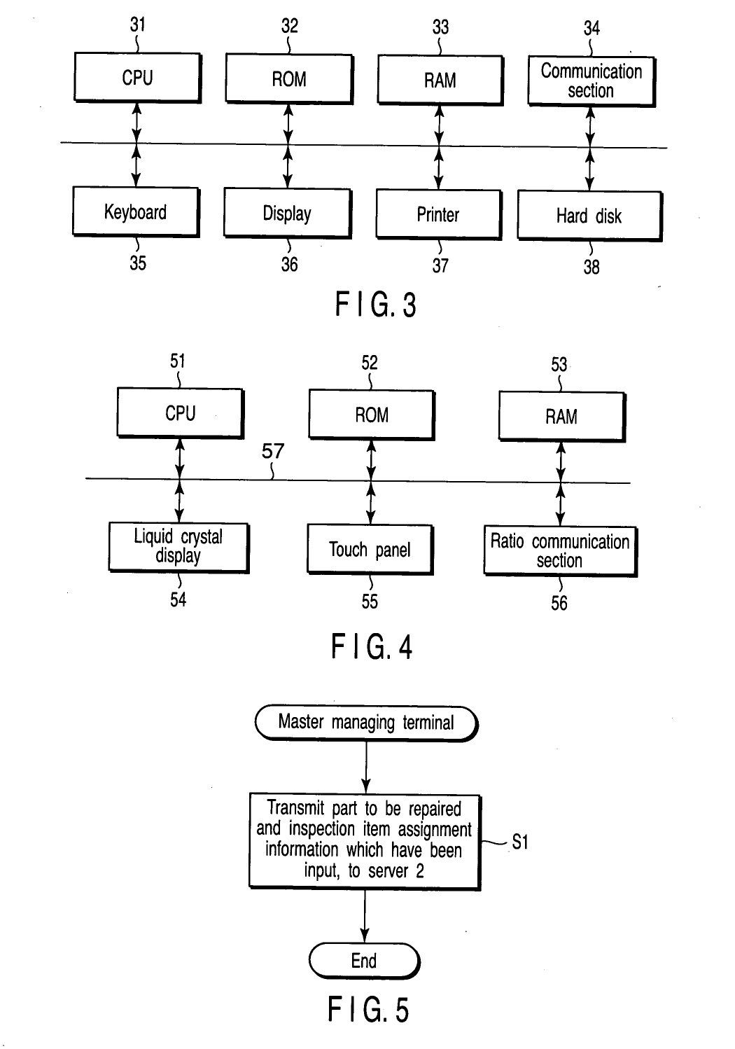

The master managing terminal 3 is operated by the manager of the production line. As shown in FIG. 3, the master managing terminal 3 is provided with a CPU 31 constituting a control section main body, a ROM 32 that stores program data used by the CPU 31 to control each section, a RAM 33 provided with a memory temporarily used by the CPU 31 to execute data transmission, reception, processing, or the like and a memory storing a small amount of data, a communication section 34 which transmits and receives data to and from the server 2 via the LAN 1, a keyboard provided with various keys to perform operations, a display 36 composed of a liquid crystal or the like and used for data display or the like, a printer 37 used to print required data, and a hard disk device 38 used to store a large amount of data. The components of the server 2 are electrically connected together by a bus line 39.

As shown in FIG. 4, each of the portable terminals 5a to 5c is provided with a CPU 51 constituting a control section main body, a ROM 52 that stores program data used by the CPU 51 to control each section, a RAM 53 provided with a memory temporarily used by the CPU 51 to execute data transmission, reception, processing, or the like and a memory storing a small amount of data, a liquid crystal display 54 used for data display, display of various types of information on the input screen, or the like, a touch panel 55 placed on the liquid crystal display 54 to input information to an input screen displayed on the liquid crystal display 54, and a radio communication section 56 that transmits and receives data to and from the access point 4 by radio. The components of the portable terminal 5a to 5c are electrically connected together by a bus line 57.

Using the master managing terminal 3, the manager inputs, for each automobile to be manufactured, inspection information as to what inspections to be carried out and which sites or parts to be inspected in each step. Moreover, the manager inputs inspection item assignment information on a part to be repaired. As a result, in accordance with the processing shown in the flowchart in FIG. 5, the inspection information and the inspection item assignment information on the part to be repaired are transmitted to the inspection master database 11 of the server 2 (step S1).

Once the inspection information for each automobile to be manufactured and for each stage is set in the inspection master database 11 of the server 2, the portable inspection terminal 5a communicates wirelessly with the server 2 in each stage. On the basis of the inspection information transmitted by the server 2, the portable inspection terminal 5a displays an inspection screen on the liquid crystal display 54. The results of inspections in each stage are input to the inspection screen.

Inspections are carried out using the portable inspection terminal 5a, with the results of the inspections transmitted to the server 2. Then, when the results of the inspections indicate that there is a defect in the automobile, the server 2 transmits the cause of the detected defect. The portable repair terminal 5b is subsequently used to repair the defect.

For some defects, repair may result in the occurrence of a secondary defect. For example, if a defect in an instrument panel is found as a result of inspections carried out using the portable inspection terminal 5a, replacing the instrument panel with a new one may result in a secondary defect in another part in association with the replacement. Consequently, after the repair of the defect, it is necessary to re-inspect other parts in which defects may occur as a result of the repair. This inspection is carried out in a repair checking stage, described later.

As described above in connection with the configuration, the inspection item assignment information for the part to be repaired has been input through the master managing terminal 3. The inspection item assignment information relate to other parts to be re-inspected because defects may occur in them as a result of the repair. The inspection item assignment information contains a set of sites to be inspected and the contents and methods of inspections.

In the repair stage, the portable repair terminal 5b transmits the information on the part to be repaired (that is, repair information) to the server 2.

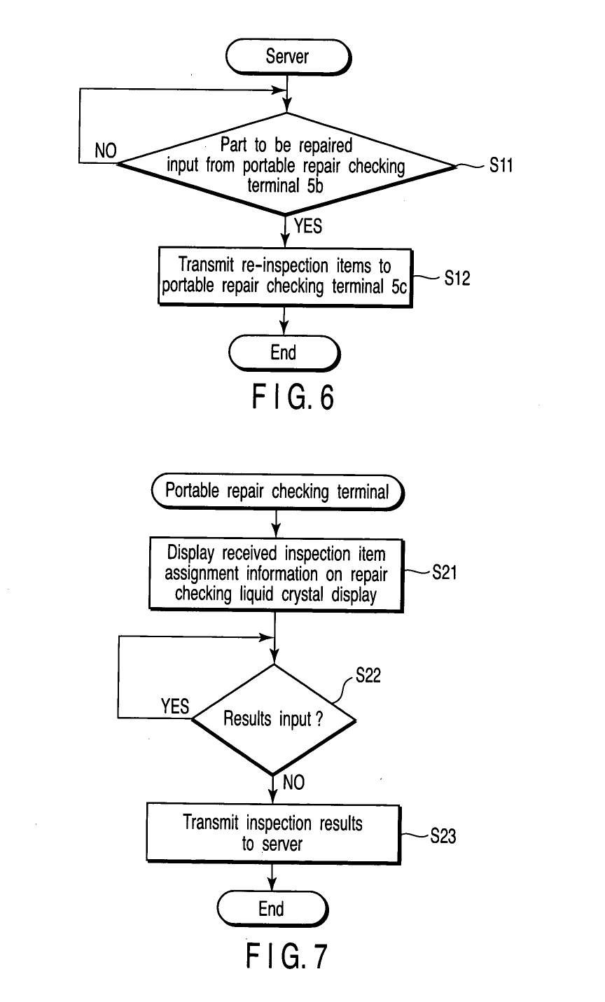

Upon receiving this information, the server 2 executes a process such as the one shown in FIG. 6. Specifically, the server 2 determines whether or not there has been any part to be repaired input by the portable repair terminal 5b (step S11). If the result of the determination in step S11 is “YES”, the server 2 transmits the inspection item assignment information on the part to be inspected to the portable repair checking terminal 5c (step S12).

Then, the portable repair checking terminal 5c executes a process shown in the flowchart in FIG. 7. Specifically, the portable repair checking terminal 5c displays the received inspection item assignment information on its own liquid crystal display 54 (step S21).

A repair checker views the display screen of the liquid crystal display 54 to input the results of the repair checks.

The terminal determines whether or not the results have been input (step S22). If the result of the determination in step S22 is “YES”, the terminal transmits the results of the inspections to the server 2 (step S23).

For example, a display area in the upper part of the display screen of the portable repair terminal 5b shows an inspection classification “A1”, an inspection content “noise”, an inspection target “power window”, and an inspection site “D seat side”. In other words, defect information is displayed indicating that there is noise in the power window.

Further, parts to be adjusted and repaired are shown in a display area in the lower part of the display screen of the portable repair terminal 5b.

The portable repair checking terminal 5c is provided with a display area that shows sites to be re-inspected in connection with the inspection target shown in the display area of the portable repair terminal 5b, and a display area that shows sites to be inspected of peripheral parts in which secondary defects may occur as a result of the repair of the part to be repaired which is shown in the display area of the portable repair inspection terminal 5b.

Buttons used to input the results of inspections are displayed at the right end of the display area showing the sites to be re-inspected.

Also at the right end of the display area that shows the sites to be inspected of the peripheral parts in which secondary defects may occur as a result of the repair of the parts to be repaired, buttons are shown which are used to input the results of inspections of the sites to be inspected of the peripheral parts in which secondary defects may occur.

When “All OK” is input as the results of the inspections of all the sites to be inspected of the peripheral parts in which secondary defects may occur as a result of the repair of the parts to be repaired, the input buttons located at the right end of the inspection area are enabled; the input buttons are used to input the results of the inspections.

As described above, in the repair checking stage, the automobile is automatically inspected for new problems that may occur in the repair stage of repairing defects found in the inspection stage. This makes it possible to reliably avoid oversights in secondary problems that may occur in the step of repairing defects.

In the description of the present embodiment, the portable inspection terminal is used as an inspection terminal, the portable repair terminal is used as a repair terminal, and the portable repair checking terminal is used as a repair checking terminal. Further, the system communicates with the server 2 via the access point 4 on the basis of the radio communication system. However, the present invention is not limited to this. It is possible to use an installed inspection terminal, repair terminal, and repair checking terminal which are set by the server 2 and LAN.

Moreover, the liquid crystal display 54 of the portable inspection terminal 5a is of the touch panel type. However, the present invention is not limited to this.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A system for managing vehicle inspections, the system comprising a server used on a vehicle production line and including an inspection master database which stores inspection items for parts to be repaired; and a repair terminal and a repair checking terminal which communicate with the server via a LAN and which are used in a plurality of inspection stages,
wherein the server comprises:
a transmitting section configured to extract, on the basis of repair information on a part to be repaired which is transmitted by the repair terminal, inspection items related to this part to be repaired, from the inspection master data, and to transmit the inspection items to the repair checking terminal as re-inspection items, and
the repair checking terminal comprises:
a display; and
a display section configured to display, on the display, the re-inspection items for the part to be repaired which have been transmitted by the server.

2. The system for managing vehicle inspections according to claim 1, wherein the display comprises an inspection result input screen to which an inspection result for each inspection item is input, and the inspection results input to the inspection result input screen are transmitted to the server.

3. A method for managing vehicle inspections which method is used for a system for managing vehicle inspections, the system comprising a server used on a vehicle production line and including an inspection master database which stores inspection items for parts to be repaired; and a repair terminal and a repair checking terminal which communicate with the server via a LAN and which are used in a plurality of inspection stages,
wherein the server comprises the step of:
on the basis of repair information on a part to be repaired which is transmitted by the repair terminal, extracting inspection items related to this part to be repaired, from the inspection master data, and transmitting the inspection items to the repair checking terminal as re-inspection items, and
the repair checking terminal comprises the step of:
displaying, on the display, the re-inspection items for the part to be repaired which has been transmitted by the server.

4. The method for managing vehicle inspections according to claim 3, further comprising the step of transmitting inspection results input to an inspection result input screen of the display to the server.
